(19) United States
(12) Patent Application Publication
(10) Pub. No.: US 2026/0370100 A1
(43) Pub. Date: Nov. 19, 2026

(54) TURBOCHARGER ACTUATOR WITH WIRELESS MODULE

(71) Applicant: Fleece Performance Engineering, Inc., Pittsboro, IN (US)

(72) Inventors: Brayden Fleece, North Salem, IN (US); Denis Latyshev, Brownsburg, IN (US); Matthew Miller, Indianapolis, IN (US); Jeff Merriman, North Salem, IN (US)

(21) Appl. No.: 19/206,901

(22) Filed: May 13, 2025

(51) Int. Cl. H02K 11/35; H02K 11/20

(52) U.S. Cl. CPC H02K 11/35; H02K 11/20; H02K 2211/03

(57) ABSTRACT

A turbocharger actuator having a housing defining an interior space, a cover secured on the housing for enclosing the interior space, a plurality of gears arranged in the interior space and a motor for driving the gears. The turbocharger actuator further includes a printed circuit board comprising a control module and a wireless module connected to the control module, wherein the wireless module is constructed to wirelessly communicate with a device located external to an engine to diagnose a condition of the turbocharger actuator or turbocharger. An embodiment of the disclosure includes a method of servicing a turbocharger actuator or turbocharger comprising using a device to wirelessly communicate with an MCU via a wireless module, identifying a fault code while the device and the MCU are in communication, determining a fault reason from the fault code, and servicing the turbocharger actuator or turbocharger based on the fault reason.

### BACKGROUND

The present disclosure relates to the field of the diagnostics, servicing and adjusting of automotive powertrain components. More specifically, the present disclosure relates to turbocharger actuators and wirelessly connecting to an external device to diagnose, service and adjust turbocharger actuators and turbochargers.

Generally, actuators are used in vehicles to actuate a particular vehicle powertrain component. An actuator/turbocharger combination may be used on diesel-fueled engines and other combustion vehicle engines. In such cases, the actuator may be used to actuate the vanes of the turbocharger.

A significant difference between a turbocharged diesel or gasoline fueled engine and a traditional naturally aspirated engine is the air entering a turbocharged engine is compressed before the fuel is injected. It is the job of the turbocharger to compress more air flowing into the engine's cylinder. When air is compressed, the oxygen molecules are packed closer together. This increase in air means that more fuel can be added for the same size engine. This then generates increased mechanical power and overall efficiency improvement of the combustion process when fuel is burned.

Currently, on-board diagnostic (“OBD”) systems are used to provide status of various vehicle sub-systems. OBD systems use a standardized digital communications port to allow access to real-time data and diagnostic fault codes, The fault codes allow for the fast identification of malfunctions within a particular vehicle subsystem.

In the case of a turbocharger actuator, a printed circuit board (“PCB”) is typically located within the housing of the actuator. The PCB includes standard components such as a control apparatus, which typically includes some form of an electronic control unit (“ECU”), such as a microcontroller unit (MCU). Loaded on the MCU will be software to accomplish various functions as associated with a particular component, Other components included with the PCB may include a power source/regulator, various LEDs, diodes, switches, inductors, resistors, transistors, and capacitors. Also included in the case of an actuator for a vehicle powertrain component, such as a turbocharger actuator, is an external control and diagnostic data bus connector on the PCB that connects the MCU with an OBD port, usually indirectly through the vehicle's electronic control unit (“ECU”).

The OBD port is constructed to provide a physical connection between the PCB components, such as the MCU and some external device used to, in the case of a turbocharger actuator, perform diagnostics, servicing and adjusting of the actuator and/or turbocharger, Various tools are available that plug into the OBD port to access OBD functions. These range from simple generic consumer-level tools to highly sophisticated original equipment manufacturer (“OEM”) dealership tools to vehicle telematic devices. One example of such a tool is an OBD diagnostics scanner, It typically includes a cord that plugs into the scanner on one end and on the other end of the cord is a mating connector that mates with the OBD port. This configuration allows the scanner to communicate with the MCU via the data bus running between the MCU and the OBD port.

In other current OBD systems, the OBD port is constructed to mate with, for example, a USB adaptor cable or a Bluetooth adapter. The USB adaptor cable allows a direct connection between the OBD port and, for example, a personal computer, laptop computer, or other computing device having a port configured to accept a USB connector. The Bluetooth adapter plugged into the OBD port allows for wireless communication with Bluetooth and/or Wi-Fi enabled devices, such as cell phones, PCs, laptop computers, tablet computers or any other computing device capable of receiving the software necessary to communicate with the MCU located on the PCB.

A shortcoming of all the current OBD systems is that they require specialized equipment to perform the desired diagnostics, servicing, or adjustments. This specialized equipment includes hand-held devices such as OBD scanner systems that mate with the OBD port, and the OBD USB adapter cables and the Bluetooth and Wi-Fi adapters that plug into the OBD port. It is desirable to have a system that allows for communication with an MCU located on an actuator's PCB without the need for any specialized equipment. The systems and methods disclosed herein solve the problems associated with prior art systems.

### SUMMARY

An embodiment of the present disclosure may include an actuator having a housing defining an interior space. The interior space is enclosed by a cover. Located within the interior space is a plurality of gears and a motor for driving the plurality of gears. A printed circuit board arranged in the interior space comprising a control module and a wireless module connected to the control module. The wireless module is constructed to allow wireless communication between a device located external to an engine and the control module so that a condition of an automotive powertrain component can be diagnosed and/or serviced.

An embodiment of the present disclosure may include a device selected from a group of devices that include a cell phone, a personal computer, a laptop computer, a computing tablet, or other electronic device constructed to be able to wirelessly communicate with the control module via the wireless module and perform diagnosing, servicing, or adjusting of the automotive powertrain component.

An embodiment of the present disclosure may include a device and wireless module that communicate by a wireless communication protocol chosen from a group comprising Bluetooth, Wi-Fi, UWB, LoRa, or Zigbee. An embodiment of the present disclosure may also include reading a fault code or an internal parameter of the automotive powertrain component to determine a fault reason.

Another embodiment of the present disclosure may include a method for wirelessly diagnosing a condition of an automotive powertrain component. The method may comprise the step of identifying an actuator to diagnose, the actuator having a housing comprising an interior space, a cover mounted on the housing for enclosing the interior space, a plurality of gears arranged in the interior space, a motor mounted in the interior space and constructed to drive the plurality of gears, a printed circuit board also arranged in the interior space. The printed circuit board may comprise a control module and a wireless module connected to the control module. The wireless module is constructed to communicate wirelessly with a device located external to an engine. The method may include the step of using the device to wirelessly communicate directly with the control module via the wireless module to diagnose a condition of the actuator.

An embodiment of the present disclosure may include the step of reading a fault code from the control module using the device as it communicates with the control module. The method may also include determining a fault reason from the fault code to determine the condition of the actuator. The actuator may be serviced to address the fault code.

### DESCRIPTION OF FIGURES

FIG. 1 is a non-limiting perspective view of an aspect of the present disclosure.

FIG. 2 is another non-limiting perspective view according to an aspect of the present disclosure. of the printed circuit board of the present disclosure.

FIG. 3 is a section view of an aspect of the present disclosure.

FIG. 4 is another non-limiting perspective view of an aspect of the present disclosure.

FIG. 5 is another non-limiting depiction of an aspect of the present disclosure.

FIG. 6 a non-limiting block diagram of a method according to one aspect of the present disclosure.

### DETAILED DESCRIPTION

For the purposes of promoting an understanding of the principles of the disclosure, reference will now be made to the embodiments illustrated in the drawings and described in the following written specification. Even though the present disclosure focuses on embodiments of an actuator having a wireless OBD system, it is understood that no limitation to the scope of the disclosure is thereby intended and that the system disclosed herein is adaptable to any prior art system as would be understood by one of ordinary skill. It is further understood that the present disclosure includes any alterations and modifications to the illustrated embodiments and includes further applications of the principles disclosed herein as would normally occur to one skilled in the art to which this disclosure pertains.

One embodiment of the actuator 1 comprises a housing 10 that includes a housing cover 20. The housing and its cover define a hollow interior space 30. A typical seal 25 made of an elastomeric material, rubber, fiber, or cork material is used as a seal between the housing cover and the housing. The seal is seated in channel 15 formed in the top of housing 10. As discussed in detail below, the hollow interior space houses multiple actuator components including a motor and various shaft and gear stacks that interface in a specific manner. Also included is a printed circuit board (“PCB”) that has various electrical and control features mounted on it.

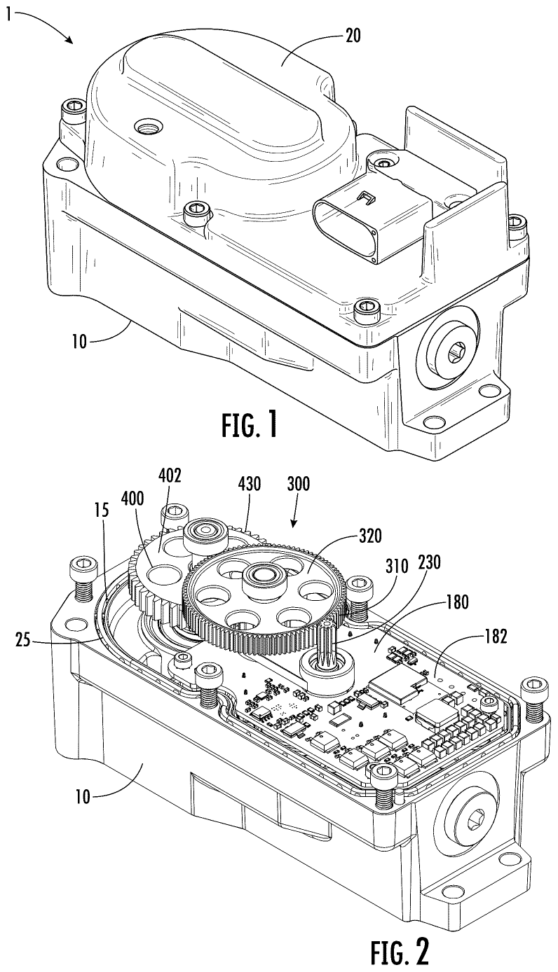

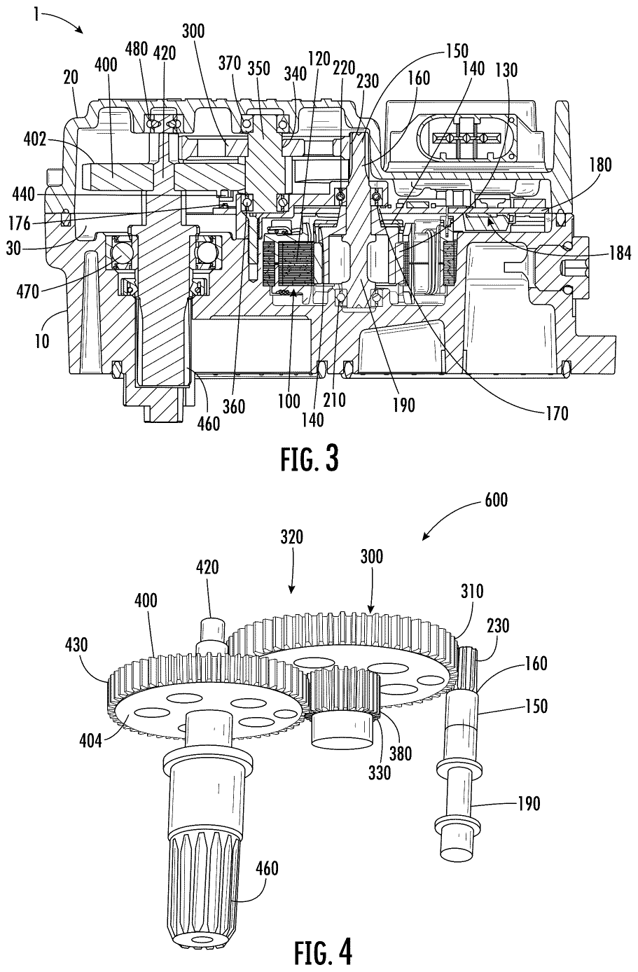

Drawings showing the basic layout and components of one embodiment of the device disclosed herein are attached hereto as FIGS. 1, 2, 3 and 4. It should be understood, that relative positional terms such as, “upper,” “lower,” “above,” “below,” “front,” “back,” “top,” “bottom” and the like, are with reference to the figures disclosed herein. While other orientations of the device are possible, it will be recognized that the relative positional terms are based on the standard orientation shown in the figures. Such positional terms should not be considered otherwise limiting.

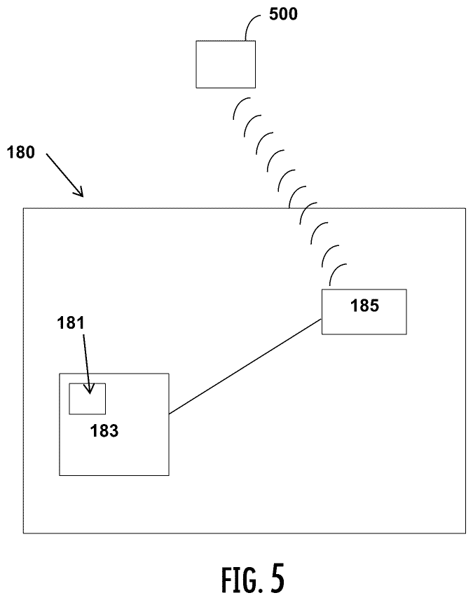

With reference to FIG. 1 though FIG. 4, an electric brushless direct current motor 100 is seated and secured in the interior space 30 of the housing 10 and secured with fasteners passing through a stationary stator 120 into the bottom of the housing casting. The motor includes the stationary stator 120 with a base mounted perpendicularly on and secured to a portion of the housing. The motor further includes a cylindrical rotor magnet 130 arranged below a sensor magnet 140, both coaxially mounted to a vertical rotor shaft 150. The rotor shaft includes an upper end 160 extending through a first opening 170 defined in a printed circuit board 180 and a lower end 190 extending through respective central apertures defined in the stator 120 and the rotor magnet 130 respectively.

The printed circuit board 180 includes a top surface 182 and a bottom surface 184. Multiple Hall Effect sensors are positioned on the bottom surface 184 of PCB 180 and are constructed to sense a change in the magnetic field generated by the sensor magnet 140 in response to the rotation of the rotor shaft 150. The rotor shaft 150 is supported by and rotatable relative to the stator 120 via a pair of ball bearings 210/220 located at opposed ends of the rotor shaft through-aperture. That is, bearing 210 is located near the bottom of the rotor shaft 150 and bearing 220 is located above the printed circuit board 180 (“PCB”) closer to the top of the rotor shaft 150. The upper end 160 of the rotor shaft 150 includes a set of gear teeth 230 extending around the circumference of the shaft.

With continued reference to FIG. 2 through FIG. 4, the gear teeth 230 are constructed to mesh with complementary gear teeth 310 located on the outer circumference of an idler gear 300. Idler gear 300 includes a top surface 320. Idler gear shaft 350 is press fit in a bearing that is seated into a centrally located aperture 340 arranged in idler gear 300. Idler gear shaft 350 includes gear teeth 380 arranged below idler gear 300 and above PCB 180. Idler gear shaft gear teeth 380 are constructed to mesh with output gear teeth 430 as described below. The lower end of idler gear shaft 350 is arranged in a bearing 360, which is seated into a bearing mid-support bracket arranged above PCB 180. The two idler gear shaft bearings 360/370 are spaced apart along the idler gear shaft 350 to facilitate rotation of the idler gear.

In addition to the first gear stack comprising gear teeth 230 located on rotor shaft 150 and second gear stack comprising idler gear 300, gear teeth 310, and idler gear shaft 350, the actuator further includes a third gear stack comprising an output gear 400 having a centrally located opening sized for receiving a geared output shaft 420. Output gear 400 includes a top surface 402 and a bottom surface 404, the bottom surface is located next to and above PCB 180. Output gear 400 further includes a set of gear teeth 430 located on the outer circumference of output gear 400. Gear teeth 430 are constructed to mesh with idler gear teeth 380.

Geared output shaft 420 extends through opening of output gear 400, and next to and perpendicular to PCB 180. The lower end of geared output shaft 420 extends out of interior space 30 and includes gear teeth 460 constructed to operably connect and move a vehicle engine component, such as the vanes of a vehicle engine turbocharger (not shown). Two geared output shaft bearings 470/480 are spaced apart along the geared output shaft 420 to support the geared output shaft and facilitate rotation. A lip seal provides a seal for the geared output shaft near the point where the output shaft exits the interior space 30.

An output position magnet 440 is located on the bottom surface 404 of output gear 400. An output position sensor 176 is positioned on the top surface 182 of PCB 180. The output position sensor 176 is positioned on the PCB and constructed to sense a change in the magnetic field generated by the output position magnet 440 in response to the rotation of the output gear 400. In operation, actuation of the motor 100 results in rotation of the rotor shaft 150 which results in the rotation of idler gear 300 which results in the rotation of the output gear 400 which results in the rotation of the geared output shaft 420 which results in the activation or movement of the vehicle engine component (not shown), such as, a nonlimiting example, the vanes of a vehicle engine turbocharger that is operably associated with and connected to the lower end of the geared output shaft 420 via gear teeth 460.

The PCB 180 is secured in the interior space 30 of the housing 10 and is located above and spaced apart from the rotor sensor magnet 140. Moreover, the bottom surface 184 of the PCB 180 is parallel to the top surface of the rotor sensor magnet 140. The rotor sensor magnet 140 is positioned in a perpendicular relationship to the rotor shaft 150 between the bottom 184 of the PCB 180 and the top of the stator 120 and parallel to both the bottom of the PCB 180 and top of stator 120. Multiple fasteners extend through the PCB 180 and into a ledge formed on the base wall of the housing 10 for directly securing the PCB 180 to the ledge formed on the base wall of the housing 10.

Referring to FIG. 5, in addition to the sensors discussed above, the PCB 180 includes a plurality of electrical/electronic components mounted to the top surface or bottom surface as needed for a particular embodiment. Electrical terminals extend from the motor 100 into and through the PCB 180 and into an electrical coupling relationship with selected electronic components located on PCB 180. Other components located on the PCB include, for example, a control module, which may be a microcontroller (“MCU”) 183 or other controller as would be understood by one of ordinary skill. The PCB may also include a wireless module 185 connected to the control module, as would be known to one of ordinary skill. The PCB 180 may include a connector constructed to mate with vehicle side power and data bus, thus providing power and communication functionality to the PCB 180. The MCU 183 is constructed to include software 181 necessary to provide control, monitoring, maintenance, and service functions necessary for operation of the actuator and the powertrain component that the actuator is mated with (not shown).

The wireless module 185 may include wireless communication capabilities such as Wi-Fi, Bluetooth, Ultra-wideband (“UWB”), other short-range IoT protocols such as Zigbee, long-range IoT protocols, such as LoRa, and other cellular networks. The wireless module may include software, as necessary, to facilitate wireless communication between MCU 183 and a device 500 remotely located from the actuator. Importantly, the wireless module 185 is constructed to communicate with external devices 500 that are most notably not connected to an OBD port via a direct connection or wirelessly via an adapter connected to the OBD port. More specifically, the wireless communication module 185 is constructed to facilitate wireless communication between the MCU 183 and an external device 500.

External device 500 may be any number of devices capable of communicating with the MCU 183 via wireless module 185 to conduct various diagnostic, servicing or adjusting functions to the actuator and/or turbocharger or other powertrain component mated with an actuator. External device 500 may include a cell phone, a personal computer, a laptop computer, a computing tablet, or any other computing device capable of communicating with MCU 183 via wireless module 185. The type of external device identified above, highlights significant advantages found in the embodiments of the present disclosure.

As long as the appropriate software is loaded on the external device 500, the device may communicate with the MCU 183 to perform various diagnostic, servicing and/or adjusting functions. No special equipment that requires an OBD port is needed to communicate with the MCU 183. Further, unlike, for example, prior art scanners that must be plugged into an OBD port, the devices 500, such as a cell phone, can be used to connect wirelessly with the actuator.

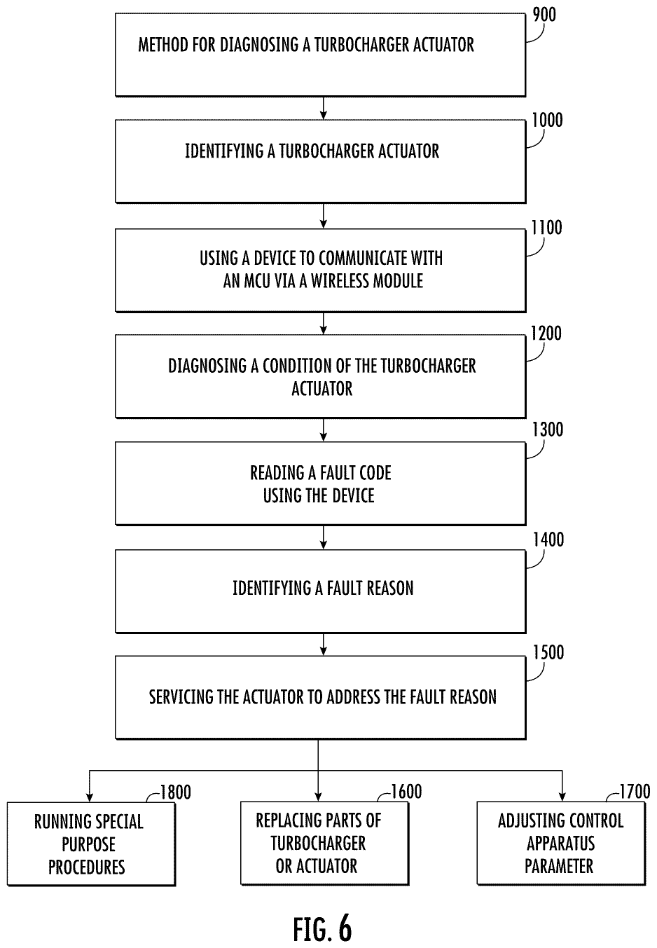

Another embodiment of the present disclosure may include a method for diagnosing, or servicing or adjusting, as appropriate, an automotive powertrain component and actuator thereof. The following method employs a turbocharger actuator to illustrate the method, but one of ordinary skill understands that the method is applicable to other automotive actuator/powertrain components. Referring to FIG. 6, a method of diagnosing 900 a turbocharger actuator 1 may include the step of identifying 1000 an turbocharger actuator to diagnose, the actuator 1 having a housing 10 with an interior space 30, a cover 20 mounted on the housing for enclosing the interior space, a plurality of gears 600 arranged in the interior space 30, a motor 100 mounted in the interior space and constructed to drive the plurality of gears, a printed circuit board 180 comprising a MCU 183, and a wireless module 185 connected to the MCU 183, wherein the wireless module is constructed to wirelessly communicate with a device 500 located external to an engine (not shown) to diagnose a condition of the actuator.

The method may further include the step of using the device 500 to communicate 1100 with the MCU 183 through the wireless module 185. As would be understood by one of ordinary skill, the MCU, and the device 500 have the appropriate software to allow them to communicate. Moreover, the device 500 and the MCU 183 have software to allow either diagnostic protocols, servicing protocols or adjusting protocols to be run on the powertrain component, such as the actuator and the turbocharger.

The method may also include the step of diagnosing a condition 1200 of the actuator or the turbocharger using the device 500 while it communicates with the MCU 183. Diagnosing a condition of the actuator, turbocharger, or other powertrain component 1200 may include reading fault codes and/or internal parameters 1300 loaded on the powertrain component, such as the actuator or turbocharger with the purpose to identify a fault reason 1400. Fault reason 1400 may include, for example an actuator electric motor fail or a turbocharger mechanical failure.

The method may include the step of servicing 1500 the actuator or turbocharger to address the condition identified in the diagnosing step 1200. Servicing may include, for example, running special purpose procedures 1600 required during regular servicing or replacement of powertrain components or subsystems thereof like actuator response time and actuation sweep range check For example, servicing may comprise replacing parts of the turbocharger, complete turbocharger, or turbocharger actuator 1700. In another embodiment of the present disclosure, servicing may include calibrating the actuator to the turbocharger.

The method of an embodiment of the disclosure may include the step of adjusting 1800 some parameter associated with a control apparatus. This step may comprise changing a parameter of the algorithm in the control apparatus like speed of actuation. The MCU 183 is located on the PCB 180 of a turbocharger actuator. The control apparatus may further include a power regulator or input and output subsystems associated with the control apparatus.

It should be understood, that relative positional terms such as, “upper,” “lower,” “above,” “below,” “front,” “back,” “top,” “bottom” and the like, are with reference to the figures of the device disclosed herein. Such positional terms should not be considered otherwise limiting. The present disclosure has been described in an illustrative manner. It is to be understood that the terminology that has been employed herein is intended to be in the nature of words of description rather than words of limitation. While there have been described herein what are considered to be exemplary embodiments of the present disclosure, other modifications of the disclosure shall be apparent to those skilled in the art from the teachings herein and, it is, therefore, desired to be secured in the appended claims all such modifications as fall within the true spirit and scope of the disclosure.

1. An actuator comprising:
a housing having an interior space;
a cover mounted on the housing for enclosing the interior space;
a plurality of gears arranged in the interior space;
a motor mounted in the interior space and constructed to drive the plurality of gears;
a printed circuit board located in the interior space comprising a control module and a wireless module connected to the control module;
wherein the wireless module is constructed to allow wireless communication between a device located external to the actuator and the control module so that a condition of the actuator can be diagnosed.

2. The actuator of claim 1 wherein the wireless module is constructed to allow wireless communication between the control module and the device so that the actuator can be serviced.

3. The actuator of claim 1 wherein the wireless module is constructed to allow wireless communication between the control module and the device so that a control parameter of the actuator can be adjusted.

4. The actuator of claim 1 wherein the device is selected from a group comprising a mobile phone, a personal computer, a laptop computer, a computing tablet, or other electronic device.

5. The actuator of claim 1 wherein the device and wireless module communicate via a wireless communication protocol.

6. The actuator of claim 1 wherein the wireless module is constructed to allow wireless communication between the device located external to the actuator and the control module so that a condition of a turbocharger can be diagnosed.

7. The actuator of claim 1 wherein diagnosing the condition of the actuator includes reading a fault code or an internal parameter of the actuator to determine a fault reason.

8. A method for wirelessly diagnosing a condition of an automotive powertrain component, the method comprising:
identifying an actuator to diagnose, the actuator having a housing comprising an interior space; a cover mounted on the housing for enclosing the interior space; a plurality of gears arranged in the interior space; a motor mounted in the interior space and constructed to drive the plurality of gears; a printed circuit board comprising a control module and a wireless module connected to the control module; wherein the wireless module is constructed to wirelessly communicate with a device located external to the actuator; and
using the device to wirelessly communicate directly with the control module via the wireless module to diagnose a condition of the actuator.

9. The method of claim 8 further including the step of reading a fault code from the control module using the device as it communicates with the control module.

10. The method of claim 9 wherein the method includes the step of determining a fault reason from the fault code to determine the condition of the actuator.

11. The method of claim 10 further including the step of servicing the actuator to address the fault reason.

12. The method of claim 10 further including the step of adjusting a parameter of the control module in response to the fault reason.

13. The method of claim 11 wherein servicing the actuator comprises replacing the actuator.

14. The method of claim 8 wherein the device is chosen from a group comprising a cell phone, a personal computer, a laptop computer, and a computing tablet.

15. The method of claim 14 wherein the device and wireless module communicate by a wireless communication protocol.

16. A method for servicing a turbocharger actuator, the method comprising the steps of:
selecting a turbocharger actuator, the turbocharger actuator having an MCU and a wireless module connected to the MCU;
using a device located remotely from the turbocharger actuator to wirelessly communicate with the MCU through the wireless module;
identifying a fault code while the device and the MCU are in wireless communication;
determining a fault reason from the fault code; and
servicing the turbocharger actuator based on the fault reason.

17. The method of claim 16, wherein the servicing step comprises replacing a part on the turbocharger actuator or a component on the turbocharger connected to the turbocharger actuator.

18. The method of claim 16 wherein the device is selected from a group comprising a cell phone, a laptop computer, a personal computer, and a computing tablet.

19. The method of claim 16 wherein the device and wireless module communicate by a wireless communication protocol.
